(19) United States
(12) Patent Application Publication
(10) Pub. No.: US 2013/0334724 A1
(43) Pub. Date: Dec. 19, 2013

(54) NON-CONTACT METHOD OF FORMING THERMOPLASTIC FOAM BOARDS

(71) Applicant: William Thomas Jones, Denfield (CA)

(72) Inventor: William Thomas Jones, Denfield (CA)

(21) Appl. No.: 13/690,007

(22) Filed: Nov. 30, 2012

Related U.S. Application Data
(60) Provisional application No. 61/564,960, filed on Nov. 30, 2011.

(51) Int. Cl. B29C 59/00

(52) U.S. Cl. CPC B29C 59/00
USPC 264/45.5; 425/403.1

(57) ABSTRACT

The present invention relates to methods and apparatuses for non-contact forming of thermoplastic-made foam boards, such as extruded polystyrene (XPS) foam boards, polyethylene foam boards, polyurethane foam boards or any other suitable thermoplastic foams, in which the forming mould or die does not come into contact with the thermoplastic foam board.

### CROSS REFERENCE TO RELATED APPLICATIONS

This application claims the benefit of the filing date of U.S. Provisional Application No. 61/564,960, filed Nov. 30, 2011, the content of which is specifically incorporated herein by reference.

### FIELD OF THE INVENTION

This invention relates in general to the forming of shapes or patterns on thermoplastic foam boards, sheets, blocks or slabs. More particularly, the present invention relates to methods and apparatuses for non-contact forming of thermoplastic-made foam boards, particularly of forming polystyrene foam boards, such as extruded polystyrene (XPS) foam boards, polyethylene foam boards, polyurethane foam boards or any other suitable thermoplastic foams, in which the forming mould or die does not come into contact with the thermoplastic foam board.

### BACKGROUND OF THE INVENTION

Thermoforming is a method of shaping articles in the presence of heat. Thermoforming normally consists of preheating a sheet of foam or non-foam thermoplastic material and bringing the preheated sheet in contact with the surface of a moulding element and forcing the preheated thermoplastic sheet to assume the configuration of the mould by impressing a second matching moulded element thereon which forces and presses the preheated thermoplastic material to generally conform to the space intermediate the machine mould elements.

One problem with the thermoforming technique for forming shapes or patterns on the surface of thermoplastic foam boards is that once the surface of the thermoplastic foam board is touched or contacted by a heated element, at or above the board materials melting point, particularly when the element has a surface area greater than ⅛th of an inch, material from the thermoplastic foam board tends to stick to the element and does not allow production to continue uninterrupted.

In the polystyrene foam industry, the process for forming shapes or patterns on the surface of polystyrene boards is normally performed most economically using hot wire cutters or machining. In such hot wire cutters, electrically isolated metal bars are energized electrically with voltage, e.g., 40 volts. Many high resistance wires, e.g., chrome nickel wires having an approximate 0.012 diam., are tensely held between the isolated metal bars. The current that flows through the high resistance wires heats them up so that they can therefore “melt” the polystyrene when it is passed through the heated wires. Hot wire processes work by using a heated wire that is generally less than about ⅛ inch thick which is capable of melting the thermoplastic material as it moves. Forming thermoplastic foam material such as XPS with heated elements having a surface area larger than the heated wires referred to before, results in residue from the melting sticking to the element and hindering production. The existing machining and hot wire methods currently in the art are used to cut out different patterns but, are generally slow and not good for continuous high production of forming surface patterns on thermoplastic foam. In addition, hot wire method produce significant scrap material. Furthermore, the use of the hot wire process may affect the vapour barrier properties of the XPS.

As stated in U.S. Pat. No. 3,917,770, another problem with the thermoforming of polystyrene foam is that “following the removal of the shaped article from the forming mould there is a tendency of the article to deform due to residual heat contained in the formed article causing forces of stress orientation to deform the still warm article. This problem is aggravated by polystyrene foam material since this material during extrusion and sheet forming operating conditions tends to be stress oriented. Thus when such stress oriented materials are subjected to reheating as during a moulding operation providing residual heat, they have a tendency to distort at elevated temperatures from a desired mould configuration thereby producing an undesired distortion or warpage in the final product.”

U.S. Pat. No. 3,917,770 describes a method of thermoforming foam polystyrene that prevents warping upon removal from moulds. According to this patent the foam polystyrene is formed by contacting a pre-heated foam sheet with matching male and female moulds at a lower temperature, i.e. a temperature below the melting point of the foam polystyrene. This only works for a certain thickness of XPS board otherwise, the extra heat required as the board thickness increases for the pre-heating process, deforms the material to a point where moulding it will be futile. Generally, the XPS board needs to be fairly thin (like coffee sleeves or foam egg cartons).

Despite the foregoing, there remains a need to develop improved methods and apparatuses for forming thermoplastic foam boards which overcome the disadvantages of the prior art and which allow for continuous, high throughput production as well as being able to form surfaces of relatively thicker thermoplastic foam boards. There is also a need to develop improved methods and apparatuses for forming thermoplastic foam boards that minimize warping upon removal from the die or mould.

### SUMMARY OF THE INVENTION

The present invention provides methods and apparatuses for use in forming a surface of a thermoplastic block or board. The methods and apparatuses of the present invention may be used in applications such as in producing thermoplastic foam sub-floor tiles or exterior building insulation having a decorative or functional surface pattern, and in producing interior insulation tiles.

In one embodiment, the present invention provides for a method of forming a desired pattern on a thermoplastic foam board. In one embodiment, the method of forming a desired pattern on a thermoplastic foam board comprises: (a) providing a thermoplastic foam board having opposing first and second faces, (b) substantially placing the first face of the thermoplastic foam board relative to an element having the desired pattern, the element being heated to a temperature sufficient that the element can form the desired pattern on the thermoplastic foam board when the element is placed at a forming, non-contact distance from the first face of the thermoplastic foam board; (c) having the heated element and the thermoplastic foam board at the forming, non-contact distance thereby forming thermoplastic foam board; and (d) obtaining the thermoplastic foam board having the desired pattern.

In one embodiment of the method of forming a desired pattern on a thermoplastic foam board, step (c) comprises moving the heated element from a start point to the forming, non-contact distance from the first face of the thermoplastic foam board and keeping the heated element at the forming non-contact distance for a time sufficient for forming the thermoplastic foam board.

In another embodiment of the method of forming a desired pattern on a thermoplastic foam board, step (c) comprises (i) moving the heated element from a start point to the forming, non-contact distance from the first face of the thermoplastic foam board; (ii) keeping the heated element for a time sufficient to start forming the thermoplastic foam board; (iv) as the thermoplastic foam board is being formed, moving the heated element towards the thermoplastic foam board while maintaining the heated element at the forming, non-contact distance from the surface of the thermoplastic foam board.

In another embodiment of the method of forming a desired pattern on a thermoplastic foam board, the method further comprises coupling the second face of the thermoplastic foam board to a substrate prior to placing the first face of the thermoplastic foam board relative to the element. In one aspect of the invention the substrate is substantially flat.

In another embodiment of the method of forming a desired pattern on a thermoplastic foam board, the thermoplastic is selected from polystyrene, polyethylene, polyurethane and polyvinyl chloride.

In another embodiment of the method of forming a desired pattern on a thermoplastic foam board, the thermoplastic is extruded polystyrene (XPS).

In another embodiment of the method of forming a desired pattern on a thermoplastic foam board, the thermoplastic foam board is 0.14 centimetres or more in thickness between the first face and the second face.

In another embodiment of the method of forming a desired pattern on a thermoplastic foam board, the thermoplastic foam board is 0.31 centimetres or more in thickness between the first face and the second face.

In another embodiment of the method of forming a desired pattern on a thermoplastic foam board, the method is a method of continuously forming the desired pattern on thermoplastic foam boards.

In one embodiment of the present invention, a method of manufacturing a subfloor panel having grooves is provided. In one embodiment, the method of manufacturing a subfloor panel having grooves comprises: (a) providing a thermoplastic foam board having opposing first and second faces, (b) substantially placing the first face of the thermoplastic foam board relative to an element capable of forming the grooves, the element being heated to a temperature sufficient that the element can form the thermoplastic foam board when the element is places at a forming, non-contact distance from the first face of the thermoplastic foam board; (c) having the heated element and the thermoplastic foam board at the forming non-contact distance thereby forming the projections on the thermoplastic foam board, and (d) obtaining the subfloor panel having the grooves.

In one embodiment of the method of manufacturing a subfloor panel Having grooves, step (c) comprises moving the heated element from a start point to the forming, non-contact distance from the first face of the thermoplastic foam board and keeping the heated element at the forming non-contact distance for a time sufficient for forming the grooves on the first surface of the thermoplastic foam board.

In another embodiment of the method of manufacturing a subfloor panel having grooves, step (c) comprises (i) moving the heated element from a start point to the forming, non-contact distance from the first face of the thermoplastic foam board; (ii) keeping the heated element for a time sufficient to start forming the grooves on the first face of the thermoplastic foam board; (iii) as the projections on the first face of the thermoplastic foam board are being formed, moving the heated element towards the first face of the thermoplastic foam board while maintaining the heated element at the forming, non-contact distance from the first face of the thermoplastic foam board.

In another embodiment of the method of manufacturing a subfloor panel having grooves, the method further comprises coupling the second face of the thermoplastic foam board to a substrate prior to placing the first face of the thermoplastic foam board relative to the element. In one aspect of the invention the substrate is substantially flat.

In another embodiment of the method of manufacturing a subfloor panel having grooves, the thermoplastic is selected from polystyrene, polyethylene, polyurethane and polyvinyl chloride.

In another embodiment of the method of manufacturing a subfloor panel having grooves, the thermoplastic is extruded XPS.

In another embodiment of the method of manufacturing a subfloor panel having grooves, the thermoplastic foam board is 0.31 centimetres or more in thickness between the first face and the second face.

In another embodiment of the method of manufacturing a subfloor panel having grooves, the method is a method of continuously manufacturing subfloor panels.

In another embodiment of the method of manufacturing a subfloor panel having grooves, the projections of the subfloor panel include a substantially flat top surface.

In one embodiment the present application provides for an apparatus for use in non-contact forming a thermoplastic foam board. In one embodiment, the apparatus for use in non-contact forming a thermoplastic foam board comprises (a) a means for supporting the thermoplastic foam board; (b) at least one element capable of being heated to a temperature sufficient that the element is capable of forming a desired pattern on the thermoplastic foam board when the heated element is placed at a forming non-contact distance from the thermoplastic foam board; and (c) means for determining the position of the thermoplastic foam board; and (d) means for controlling movement of the element towards the thermoplastic foam board whereby the element is kept at a distance of no less than the non-contact, forming distance from the thermoplastic foam board.

These and other aspects of the invention will become apparent from the detailed description by reference to the following Figures.

### BRIEF DESCRIPTION OF THE FIGURES

FIGS. 1 A-D illustrate a process of forming a thermoplastic foam board with an apparatus according to one embodiment of the present invention.

FIG. 2 illustrates a die used for forming a thermoplastic foam board in accordance with one embodiment of the present invention.

FIG. 3 A illustrates a top view of a thermoplastic foam board formed with the die shown in FIG. 2 in accordance with one embodiment of the present invention. FIG. 3B illustrates cross-sectional side view of the formed thermoplastic foam board of FIG. 3 A.

### DETAILED DESCRIPTION OF THE INVENTION

### Definitions

Unless defined otherwise, all technical and scientific terms used herein have the same meaning as commonly understood by one of ordinary skill in the art to which this invention belongs. Also, unless indicated otherwise, except within the claims, the use of “or” includes “and” and vice versa. Non-limiting terms are not to be construed as limiting unless expressly stated or the context clearly indicates otherwise (for example “including”, “having” and “comprising” typically indicate “including without limitation”). Singular forms including in the claims such as “a”, “an” and “the” include the plural reference unless expressly stated otherwise. In this specification and in the claims that follow, reference will be made to a number of terms that shall be defined to have the meanings below. All numerical designations, e.g., dimensions and weight, including ranges, are approximations that typically may be varied (+) or (−) by increments of 0.1, 1,0, or 10.0, as appropriate. All numerical designations may be understood as preceded by the term “about”.

In this document the term “forming” means creating a contoured surface configuration, pattern, or shape on a surface of a thermoplastic foam board, sheet, block or slab. Forming may include forming a decorative or functional configuration, pattern or shape on the surface of a thermoplastic foam board, sheet, block or slab.

The term “thermoplastic” refers to a polymer that is capable of softening or fusing when heated and of hardening again when cooled. Examples of thermoplastics include polystyrene, polyethylene, polyurethane and polyvinyl chloride. For the purpose of this document, thermoplastic includes also extruded polystyrene (XPS).

In this document the term “blank” refers to an unformed (i.e. a blank) thermoplastic foam board. The blank may be presented in a number of suitable shapes including block, board, sheet, or slab. For simplicity in this document the term “board” will be used in reference to the number of suitable shapes. The board may have opposing first and second faces or surfaces.

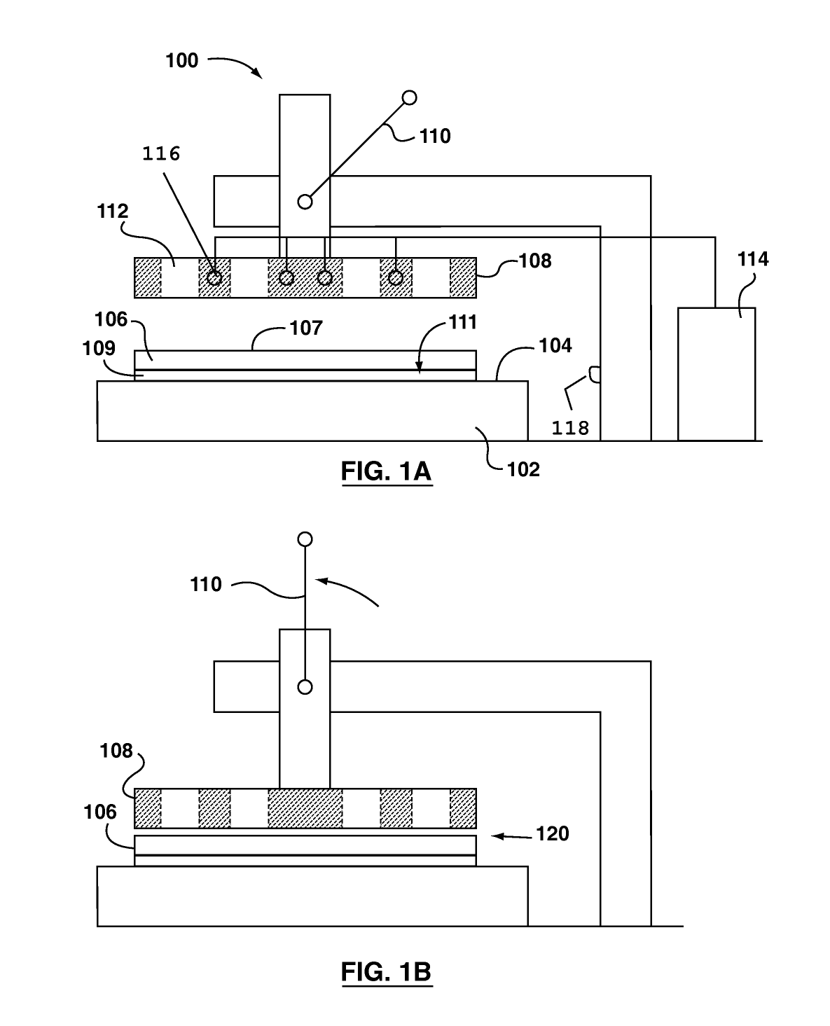

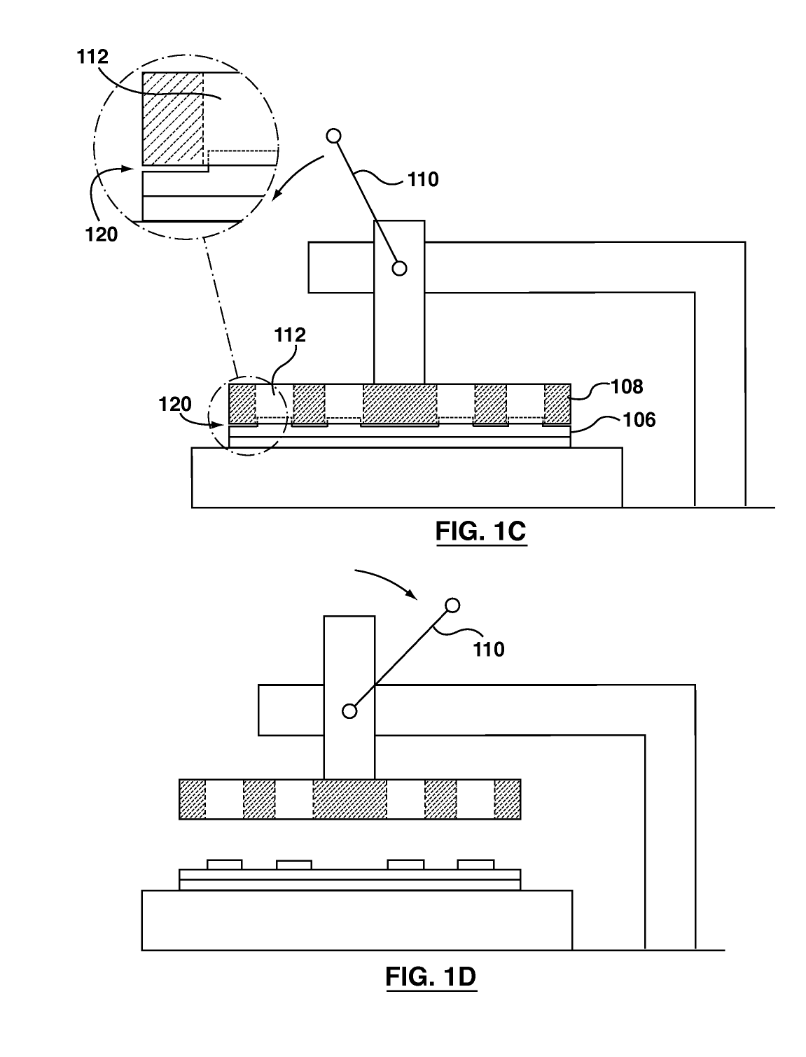

With reference to FIG. 1, blank 106 may be a board that includes two major opposing surfaces or faces 107, 111. Surface 107 being the surface of blank 106 to be formed. The distance between the two faces 107, 111 define the thickness of the board. The methods of the present invention may be used for boards having more than ⅛^{th} of an inch in thickness. In aspects of the present invention, the thermoplastic board may be ⅛^{th} of an inch or thicker.

In one embodiment, the present invention relates to apparatuses for forming a blank.

The present invention allows the continuous production of forming of boards of foam thermoplastic blanks, such as production of XPS foam insulation boards. The process for forming the surfaces of thermoplastic foam boards according to one embodiment includes heating an element having a desired pattern, form or shape, up to a desired temperature (usually melting point of the blank, or higher) and moving the heated element towards the surface of the blank to be formed and to a desired distance from the surface of the board, but without contacting the surface of the blank being formed. The element may be a die or a mould.

Referring to FIG. 1 A, a forming apparatus 100 according to one embodiment of the present invention may include a base 102 having a relatively flat surface 104 adapted for supporting a blank thermoplastic 106. The apparatus 100 may also include at least one element 108 having a desired pattern. The die 108 may be machined into a surface of a plate as shown in FIG. 1 A. The pattern may be formed into the die and/or cut entirely through the die. The die 108 shown in the figures include a pattern made of a plurality of circular cut outs 112, however, it should be understood by a person of ordinary skill in the art that a variety of other patterns may be possible. Alternatively, the die may be mounted or coupled to a plate or plates (not shown). The apparatus 100 may be coupled to a power source 114, such as a voltage source, whereby electric current may heat the die to a desired temperature, usually higher than the melting temperature of the thermoplastic foam board to be formed. The desired temperature may be a temperature capable of forming the blank without contacting the bank. The desired temperature may be the melting point of the thermoplastic material or more. For example, as the case of XPS the desired temperature may be a temperature of 240 degrees Celsius. As illustrated in FIG. 1A, in aspects of the present invention the die or mould 108 may be heated with heaters 116 channelled incorporated into the mould 108 itself. Power source 114 and heaters 116 have been obviated and are not shown in FIGS. 1B-1D, however, it should be understood that the apparatuses of FIGS. 1B-1D include also the power source and heaters illustrated in FIG. 1A.

In one embodiment of the present invention, the die or plate carrying the die, may be the top or upper part of a standard mechanical press, and may be a slidable top ram plate. With reference to FIG. 1, die 108 may be lowered and lifted relative to the base 102, for example the die may be moved manually with lever means 110, or it may be moved along slide guides of a framework of the press (not shown). The reciprocal motion of the die may be driven manually, by a servo-driven mechanism, which may include a servo motor, hydraulically or pneumatically. A brake, which may be pneumatic brake, may be included for substantially holding the ram during final forming of the thermoplastic blanks.

In one embodiment, the apparatus of the present invention may be linked to robots which may allow for high throughput and automation of the apparatus and automation of processes according to the present invention. For example, robots for loading of a blank on the base of the apparatus, and for unloading of the formed thermoplastic foam board, may be incorporated into a system which includes the apparatus of the present invention. The apparatus may also include locating means 118 for determining the location or position of face 107. Information from the locating means may be used to avoid contact of the die 108 with the board 109. Locating means may include light sensors, ultrasound sensors and so Forth. The die, the power source, the brake, the robots, the locating means and other components of the apparatus of the present invention may be programmable and automatically controlled by linking the die, power source, the locating means, robots and other components of the apparatus of the present invention to a computer unit. The computer unit may then control loading of a blank on the base of the apparatus, unloading of the formed thermoplastic foam board, temperature of the die, speed of the die, movement of the die, distance of the die from the blank, and so forth.

The plate and die may include venting apertures for allowing venting of gases that may be produced when forming blanks (not shown). In aspects of the present invention, the apertures may be part of the pattern of the die. The final formed product may include areas that may have the pre-formed thickness of the board, (i.e. areas of the board which may not be formed because they were aligned with a venting aperture and not exposed to sufficient heat).

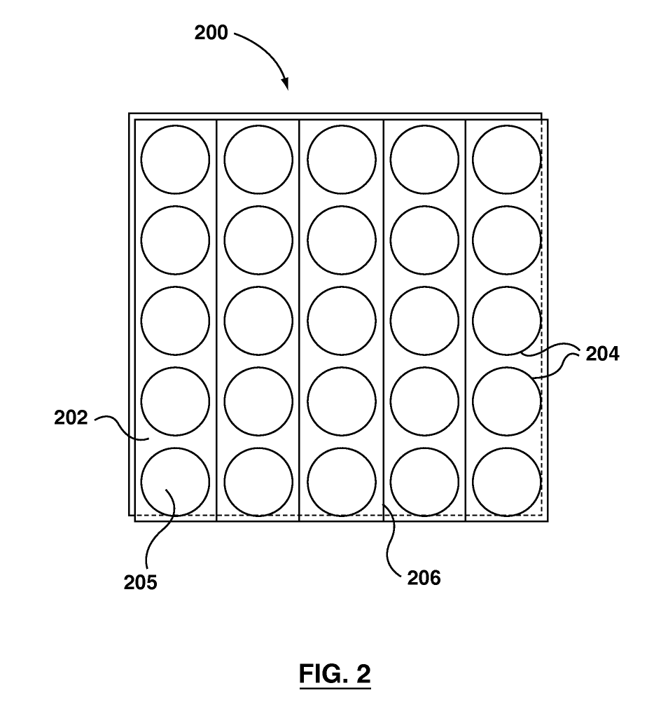

Referring to FIG. 2, a die 200 in accordance to one embodiment of the present invention may include a surface 202 having a pattern 204 for forming the blank. The pattern 204 illustrated in the die 200 of FIG. 2 includes a plurality of cut-outs 205 for desired form pattern. The die 200 may also include heater channels 206 running along the surface for distribution of heat throughout the die 200.

In aspects of the present invention, the die may be made of an efficient thermal conductor such aluminium or aluminium alloy, or any other suitable material.

FIGS. 1 A-D describe one embodiment of the forming apparatus. In another embodiment, not illustrated, the die may be etched on the surface of a substantial cylindrical element. The cylindrical element may be heated to the desired temperature sufficient for forming the thermoplastic foam board at a non-contact distance. Driving means may rotate the cylinder such that it may roll over the surface of the thermoplastic foam board, but at the non-contact distance.

Method of Forming Thermoplastic Foam Boards

In one embodiment, the present invention relates to a method for forming a surface of a thermoplastic foam board. The forming method may include (a) providing a thermoplastic foam board having opposing first and second faces, (b) substantially placing the first face of the thermoplastic foam board relative to an element having the desired pattern, the element being heated to a temperature sufficient that the element can form the desired pattern on the thermoplastic foam board when the element is placed at a forming, non-contact distance from the first face of the thermoplastic foam board; (c) having the heated element and the thermoplastic foam board at the forming non-contact distance thereby forming thermoplastic foam board; and (d) obtaining the thermoplastic foam board having the desired pattern.

FIGS. 1A-1D illustrate a process in accordance to one embodiment of the present invention. With reference to FIG. 1 A, the process may start by placing a blank 106 on to the surface 104 of bed 102 substantially directly under the heating element 108. In the example of FIGS. 1 A-D, the blank includes a face 111 substantially adhered to a substrate 109 thereby leaving face 107 exposed. In this case, the blank 106 is placed on the bed 102 by placing the substrate 109 onto the bed 102, such that exposed face 107 of blank 106 may be formed by die 108. Die 108 may include a desired pattern. In the die 108 the pattern is represented by cut-outs 112. The desired forming temperature of die 108 may be controlled by the power source 114. Once die 108 reaches the desired temperature, the apparatus 100 may be activated such that the heated element 108 may move from a home or start position to a forming, non-contact position. With reference to FIG. 1 B, the die 108 may be lowered (for example by pulling or pushing handle 110, but it may also be automatic powered hydraulically or by a servo motor) from the home position to a forming, non-contact point, which may be at a distance of about 0.5-10 mm from the surface of the thermoplastic material to be formed. The heated element may travel at a specific speed and to a desired distance from the blank with the proviso that the heated element 108 may not come into contact with the material 106 to be formed. As illustrated in FIG. 1 B, a non-contact, forming distance between blank 106 and die 108 is illustrated by the space having reference numeral 120. As the die 108 reaches the non-contact, forming distance 120, the surfaces of the die 108 surrounding cut-outs 112, start forming face 107 of the blank 106. With reference to FIG. 1 C, as the thermoplastic material burns off and melts away the heated die 108 may continue its movement towards the blank 106 without surface contact (i.e. without contacting the blank 106) at a distance 120. This movement towards the blank 106 from the forming point may be at a speed that allows the blank 106 to be formed while preventing the die 108 from contacting the blank 106. Also shown in FIG. 1 C is a zoom-in view of non-contact forming distance 120 in accordance with one embodiment of the present invention. With reference to FIG. 1 D, once the board 106 is formed, the die 108 may be brought back to the home position, and the formed thermoplastic foam board 106 may be removed from the bed 102.

The method of the present invention may be carried out manually or automatically. In one embodiment of the method of the present invention, locating means 118 may be used to locate face 107 relative to die 108. The signal from the locating means may be send to a computer unit which may control movement of the die so as to avoid contact between the thermoplastic foam board being formed and die 108.

It should be understood that the forming process of the present invention may work with the heated element moving upwards and the thermoplastic material above the element, or with the heated element moving downwards and the thermoplastic material below the element. Sideways movement are also covered by the methods of the present invention.

The temperature of the forming element, type of thermoplastic material to be formed and speed of the heated element towards the thermoplastic foam board may be correlated. The thermoplastic material's melt point may be related to the temperature of the element and the temperature of the element may relate to the speed it travels towards the thermoplastic material. The temperature of the element may be the melting point of the blank, or higher.

The element, mould or die, after reaching the depth of the desired shape, may return to its starting, home position. The formed product may then be removed and the process may be repeated. Because no residue of the thermoplastic material attaches to the element, the method of the present invention allow for a continuous, uninterrupted process. In one embodiment, the blank to be formed may be thicker than ⅛^{th} of an inch (about 0.14 centimetres). In another embodiment, the blank may be thicker than ⅛^{th} of an inch (about 0.31 centimetres).

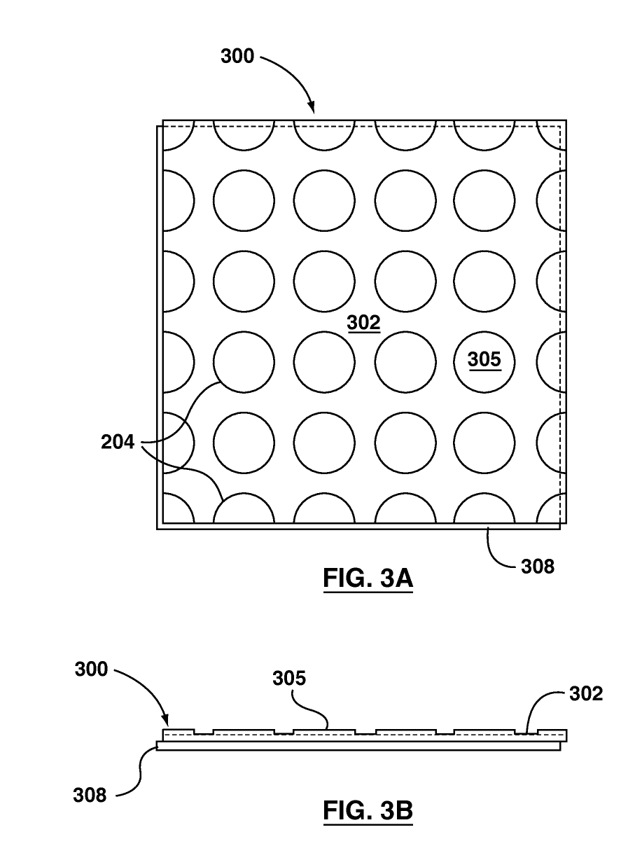

As described above, to keep the blank 106 substantially flat during the forming process of the present invention, face 111 of the blank 106 opposite to the face 107 to be formed, may be substantially coupled, fixed, or adhered to a substrate 109 which may be a substantially flat board made of wood or any other suitable material, prior forming the surface 107 of the blank 106. The blank 106 may then be placed on the surface 104 of the bed 102 by placing the substrate 109 on the surface 104, such that face 107 of blank 106 may be exposed to die 108. It should be understood that the blank may be formed without being adhered first to the substrate but, in this case, the forming apparatus may need to include means for holding the blank substantially flat. For example a vacuum table that sucked the board substantially flat before forming. Having the blank adhered to a substrate, may also serve to prevent warping of the blank after it is formed. FIGS. 3 A and B illustrate an exemplary thermoplastic foam board 300 having a surface adhered to a substantially flat substrate 308. FIGS. 3 A and B illustrate board 300 formed with the die 200 of FIG. 2. The formed board 300 includes a surface 302 which are grooves that delineate projections 305. The projections 305 correspond to the cut-outs 205 of the die 200 illustrated in FIG. 2. The projections may include a substantially flat top surface. That is, the projections 305 represent the sections of the board 300 that were not melted, other than the peripheral edges of the projections, by the surface 202 of the die 200 surrounding die cut-outs 205.

The apparatuses and methods of the present invention may be suitable to form shapes or patterns into surfaces of foam boards of polyethylene, polyvinyl chloride, polyurethane sheets, or polystyrene such as XPS insulation boards. Almost any thermoplastic may be used.

For example, the methods of the present invention may be used for the manufacturing of a foundation insulation panel. In one embodiment, the method of manufacturing a foundation insulation panel may include (a) substantially placing a first face of a thermoplastic foam board relative to a die capable of forming grooves on the first face of the thermoplastic foam board, the die being heated to a temperature sufficient that the die can form the first face of the thermoplastic foam board when the die is placed at a forming, non-contact distance from the first face of the thermoplastic foam board; (b) having the heated die and the first face of the thermoplastic foam board at the forming non-contact distance; (c) forming the grooves on the first face of the thermoplastic foam board, and (d) obtaining the thermoplastic foundation insulation board having grooves on the first face.

In one embodiment, step (b) may include moving the heated die from a start point to the forming, non-contact distance from the first face of the thermoplastic foam board and keeping the heated die at the forming non-contact distance for a time sufficient for forming the grooves on the first surface of the thermoplastic foam board. In another embodiment, (b) may include (i) moving the heated die from a start point to the forming, non-contact distance from the first face of the thermoplastic foam board; (ii) keeping the heated die for a time sufficient for forming the grooves on the first face of the thermoplastic foam board; (iv) as the first face of the thermoplastic foam board is being formed, moving the heated die towards the first face of the thermoplastic foam board while maintaining the heated die at the forming, non-contact distance from the first face of the thermoplastic foam board.

In another embodiment of the method of manufacturing a foundation insulation board, the second face of the thermoplastic foam board may be adhered, coupled or fixed to a substantially flat substrate prior to placing the first face of the thermoplastic foam board relative to the die.

Advantages of the invention may include: (i) the continuous production of forming surface area shapes onto thermoplastic foam boards (5-12 second cycle time in the case of XPS); the methods of the present invention allow to continuously and repeatably produce formed thermoplastic foam boards, since there is no sticking of thermoplastic material on the forming element which would necessitate to be removed; (ii) no production of scrap thermoplastic material; (iii) high throughput production of thermoplastic products such as floating or non-floating XPS sub-floor panels; (iv) less expensive start up costs than injection and reaction moulding; (v) in many cases less expensive part costs than injection and reaction moulding; (vi) as a result of the methods of the present invention, the heated element (die or mould) seals the outer skin of the thermoplastic material, which effectively keeps at least same vapour barrier properties of the untreated thermoplastic material.

I claim:

1. A method of forming a desired pattern on a thermoplastic foam board, the method comprising (a) providing a thermoplastic foam board having opposing first and second faces, (b) substantially placing the first face of the thermoplastic foam board relative to an element having the desired pattern, the element being heated to a temperature sufficient that the element can form the desired pattern on the thermoplastic foam board when the element is placed at a forming, non-contact distance from the first face of the thermoplastic foam board; (c) having the heated element and the thermoplastic foam board at the forming, non-contact distance thereby forming thermoplastic foam board; and (d) obtaining the thermoplastic foam board having the desired pattern.

2. The method of forming a desired pattern on a thermoplastic foam board of claim 1, wherein step (c) comprises moving the heated element from a start point to the forming, non-contact distance from the first face of the thermoplastic foam board and keeping the heated element at the forming non-contact distance for a time sufficient for forming the thermoplastic foam board.

3. The method of forming a desired pattern on a thermoplastic foam board of claim 1, wherein step (c) comprises (i) moving the heated element from a start point to the forming, non-contact distance from the first face of the thermoplastic foam board; (ii) keeping the heated element for a time sufficient to start forming the thermoplastic foam board; (iv) as the thermoplastic foam board is being formed, moving the heated element towards the thermoplastic foam board while maintaining the heated element at the forming, non-contact distance from the surface of the thermoplastic foam board.

4. The method of forming a desired pattern on a thermoplastic foam board of claim 1, wherein the method further comprises coupling the second face of the thermoplastic foam board to a substrate prior to placing the first face of the thermoplastic foam board relative to the element.

5. The method of forming a desired pattern on a thermoplastic foam board of claim 4, wherein the substrate is substantially flat.

6. The method of forming a desired pattern on a thermoplastic foam board of claim 1, wherein the thermoplastic is selected from polystyrene, polyethylene, polyurethane and polyvinyl chloride.

7. The method of forming a desired pattern on a thermoplastic foam board of claim 1, wherein the thermoplastic is extruded polystyrene (XPS).

8. The method of forming a desired pattern on a thermoplastic foam board of claim 1, wherein said thermoplastic foam board is 0.14 centimetres or more in thickness between the first face and the second face.

9. The method of forming a desired pattern on a thermoplastic foam board of claim 1, wherein said thermoplastic foam board is 0.31 centimetres or more in thickness between the first face and the second face.

10. The method of forming a desired pattern on a thermoplastic foam board of claim 1, wherein said method is a method of continuously forming the desired pattern on thermoplastic foam boards.

11. A method of manufacturing a subfloor panel having grooves, the method comprising: (a) providing a thermoplastic foam board having opposing first and second faces, (b) substantially placing the first face of the thermoplastic foam board relative to an element capable of forming the grooves, the element being heated to a temperature sufficient that the element can form the thermoplastic foam board when the element is placed at a forming, non-contact distance from the first face of the thermoplastic foam board; (c) having the heated element and the thermoplastic foam board at the forming, non-contact distance thereby forming the grooves on the thermoplastic foam board, and (d) obtaining the subfloor panel having the grooves.

12. The method of manufacturing a subfloor panel of claim 11, wherein step (c) comprises moving the heated element from a start point to the forming, non-contact distance from the first face of the thermoplastic foam board and keeping the heated element at the forming non-contact distance for a time sufficient for forming the grooves on the first surface of the thermoplastic foam board.

13. The method of manufacturing a subfloor panel of claim 11, wherein step (c) comprises (i) moving the heated element from a start point to the forming, non-contact distance from the first face of the thermoplastic foam board; (ii) keeping the heated element for a time sufficient to start forming the grooves on the first face of the thermoplastic foam board; (iii) as the projections on the first face of the thermoplastic foam board are being formed, moving the heated element towards the first face of the thermoplastic foam board while maintaining the heated element at the forming, non-contact distance from the first face of the thermoplastic foam board.

14. The method of manufacturing a subfloor panel of claim 11, wherein the method further comprises coupling the second face of the thermoplastic foam board to a substrate prior to placing the first face of the thermoplastic foam board relative to the element.

15. The method of manufacturing a subfloor panel of claim 11, wherein the thermoplastic is selected from polystyrene, polyethylene, polyurethane and polyvinyl chloride.

16. The method of manufacturing a subfloor panel of claim 11, wherein the thermoplastic is extruded XPS.

17. The method o of manufacturing a subfloor panel of claim 11, wherein said thermoplastic foam board is 0.31 centimetres or more in thickness between the first face and the second face.

18. The method of manufacturing a subfloor panel of claim 11, wherein said method is a method of continuously manufacturing subfloor panels.

19. The method of manufacturing a subfloor panel of claim 11, wherein the projections of the subfloor panel include a flat top surface.

20. An apparatus for use in non-contact forming a thermoplastic foam board, the apparatus comprising (a) a means for supporting the thermoplastic foam board; (b) at least one element capable of being heated to a temperature sufficient that the element is capable of forming a desired pattern on the thermoplastic foam board when the heated element is placed at a forming non-contact distance from the thermoplastic foam board; and (c) means for determining the position of the thermoplastic foam board; and (d) means for controlling movement of the element towards the thermoplastic foam board whereby the element is kept at a distance of no less than the non-contact, forming distance from the thermoplastic foam board.
